(19) United States
(12) Patent Application Publication
(10) Pub. No.: US 2025/0079602 A1
(43) Pub. Date: Mar. 6, 2025

(54) BATTERY PACK

(71) Applicant: TOYOTA JIDOSHA KABUSHIKI KAISHA, Toyota-shi (JP)

(72) Inventor: Koichi KATO, Toyota-shi (JP)

(73) Assignee: TOYOTA JIDOSHA KABUSHIKI KAISHA, Toyota-shi (JP)

(21) Appl. No.: 18/609,131

(22) Filed: Mar. 19, 2024

(30) Foreign Application Priority Data
Aug. 29, 2023 (JP) 2023-138907

(51) Int. Cl. H01M 50/242; B60K 1/04; H01M 50/249

(52) U.S. Cl. CPC H01M 50/242; B60K 1/04; H01M 50/249; B60K 2001/0438; H01M 2220/20

(57) ABSTRACT

A battery pack includes an upper cover and a lower case. The upper cover is disposed to face a floor panel of a vehicle. The lower case is combined with the upper cover. In the width direction of the vehicle, the open edges of the lower cases are combined with the left end portion and the right end portion of the upper cover to form a left flange and a right flange, respectively. In the width direction of the vehicle, each of the upper surfaces of the left flange and the right flange is positioned below the upper surface of the upper cover facing the floor panel. The upper surface of the upper cover facing the floor panel forms a step with each of the upper surfaces of the left flange and the right flange.

### CROSS-REFERENCE TO RELATED APPLICATION

This application claims priority to Japanese Patent Application No. 2023-138907 filed on Aug. 29, 2023, incorporated herein by reference in its entirety.

### BACKGROUND

### 1. Technical Field

The present disclosure relates to a battery pack housing a battery stack to be mounted on a vehicle.

### 2. Description of Related Art

Japanese Patent No. 6451685 discloses an attachment structure for a battery pack that is attached to an underbody of a vehicle. In this conventional structure, the underbody includes a floor panel bridged between frame members of the vehicle. The battery pack includes an upper cover disposed to face the floor panel, and a lower case combined with the upper cover. A battery stack is housed in the space formed between the upper cover and the lower case. In addition, frames are provided on the side surfaces of the battery pack on the front side and the rear side of the vehicle, respectively. The battery pack is attached to the frame members through these frames. That is, in the conventional structure, the battery pack is attached to the underbody at the positions of the frame members on the front and rear sides of the vehicle.

### SUMMARY

It is assumed that the battery pack is attached to the frame members on the left and right sides of the vehicle. In this case, it is important to maintain the structure of the battery pack when external forces are input from the left or right direction. However, the battery pack with the conventional structure has a problem in that the mating surface between the upper cover and the lower case tends to open easily because the upper cover is a simple plate-shaped member.

It is an object of the present disclosure to provide a battery pack that has high resistance to external forces applied from the left or right direction of a vehicle when the battery pack is attached to frame members on the left or right side of the vehicle.

The present disclosure relates to a battery pack for housing a battery stack to be mounted on a vehicle, and has the following features. The battery pack includes an upper cover and a lower case. The upper cover is disposed to face a floor panel of the vehicle. The lower case is combined with the upper cover. In the width direction of the vehicle, the open edges of the lower cases are combined with the left end portion and the right end portion of the upper cover to form a left flange and a right flange, respectively. The left flange is attached to a left frame member of the vehicle provided on the left side of the floor panel. The right flange is attached to a right frame member of the vehicle provided on the right side of the floor panel. In the width direction, each of the upper surfaces of the left flange and the right flange is positioned below the upper surface of the upper cover facing the floor panel. The upper surface of the upper cover facing the floor panel forms a step with each of the upper surfaces of the left flange and the right flange.

According to the battery pack of the present disclosure, the upper surface of the upper cover forms a step with each of the upper surfaces of the left flange and the right flange. Therefore, the opening of the mating surface between the upper cover and lower case can be suppressed by the step countering external forces input from the left or right direction of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating an arrangement example of a battery pack according to an embodiment of the present disclosure;

FIG. 2 is a view for explaining a configuration example of the battery pack according to the embodiment;

FIG. 3 is a view illustrating a characteristic portion of the battery pack illustrated in FIG. 2;

FIG. 4 is a view for explaining the effects of the battery pack according to the embodiment;

FIG. 5 is a view for explaining the effects of the battery pack according to the embodiment; and

FIG. 6 is a view for explaining the effects of the battery pack according to the embodiment.

### DETAILED DESCRIPTION OF EMBODIMENTS

Embodiments of the present disclosure will be described below with reference to the drawings. However, the structures and the like described in the following embodiments are not necessarily essential to the disclosure, unless specifically indicated or clearly specified as such in principle.

### 1. Battery Pack

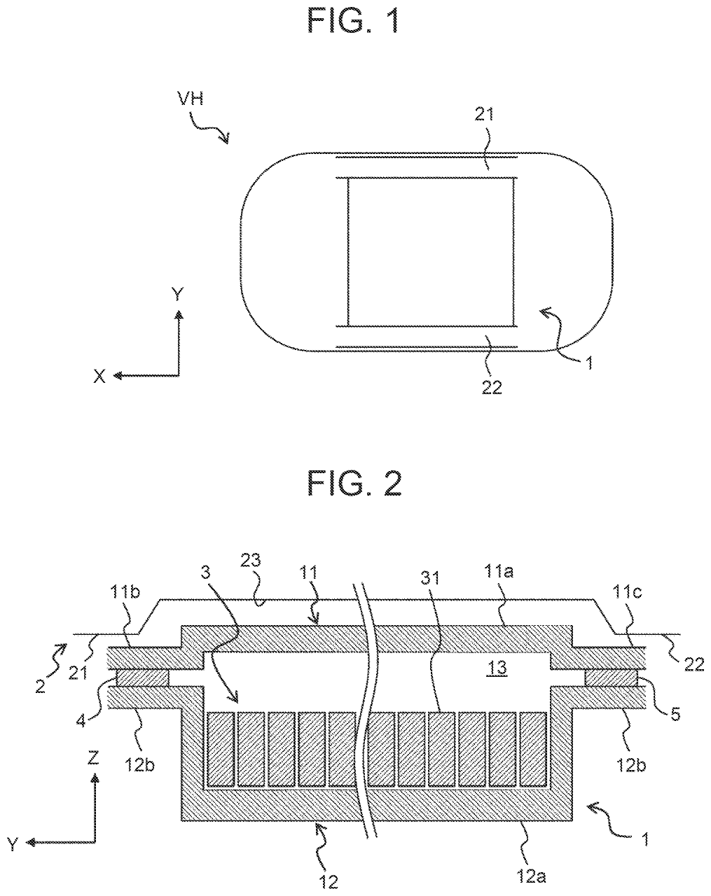

FIG. 1 is a view illustrating an arrangement example of a battery pack 1 according to an embodiment of the present disclosure. FIG. 2 is a view for explaining a configuration example of the battery pack 1. Note that the X-axis presented in FIG. 1 corresponds to the front-rear direction (length direction) of a vehicle VH, the Y-axis presented in FIGS. 1 and 2 corresponds to the left-right direction (width direction) of the vehicle VH, and the Z-axis presented in FIG. 2 corresponds to the up-down direction (height direction) of the vehicle VH. More specifically, the positive X-axis direction corresponds to the forward direction, the positive Y-axis direction corresponds to the right direction, and the positive Z-axis direction corresponds to the upward direction.

As illustrated in FIGS. 1 and 2, the battery pack 1 is attached to an underbody 2 of the vehicle VH. The underbody 2 includes a right frame member (right side frame) 21, a left frame member (left side frame) 22, and a floor panel 23. The floor panel 23 is bridged between the right frame member 21 and the left frame member 22. The positions where the battery pack 1 is attached to the underbody 2 are the respective lower surfaces of the right frame member 21 and the left frame member 22 (i.e., the positions outside the vehicle cabin). For example, the battery pack 1 is attached to the underbody 2 by a fastening member that connects the lower surface of the battery pack 1 and the upper surface of the underbody 2.

As illustrated in FIG. 2, the battery pack 1 includes an upper cover 11 and a lower case 12. The upper cover 11 is formed of a central portion 11a, a right end portion 11b, and a left end portion 11c. The central portion 11a faces the floor panel 23. The right end portion 11b faces the right frame member 21. The left end portion 11c faces the left frame member 22. The upper surface of the central portion 11a is positioned above the respective upper surfaces of the right end portion 11b and the left end portion 11c. The upper surface of the central portion 11a forms a step with each of the upper surfaces of the right end portion 11b and the left end portion 11c.

The lower case 12 is formed of a case portion 12a and open edges 12b extending in the left-right direction of the vehicle VH at the opening positions of the case portion 12a. The lower case 12 is combined with the upper cover 11. A battery stack 3 is housed in a space 13 surrounded by the lower surface of a central portion 11a and the upper surface and the side surfaces of the case portion 12a. The battery stack 3 is configured by stacking a large number of single cells. In the example illustrated in FIG. 2, the stacking direction of the large number of single cells is the width direction of the vehicle VH. The battery stack 3 is a rechargeable and dischargeable secondary battery, and an example of such a secondary battery is a lithium-ion secondary battery.

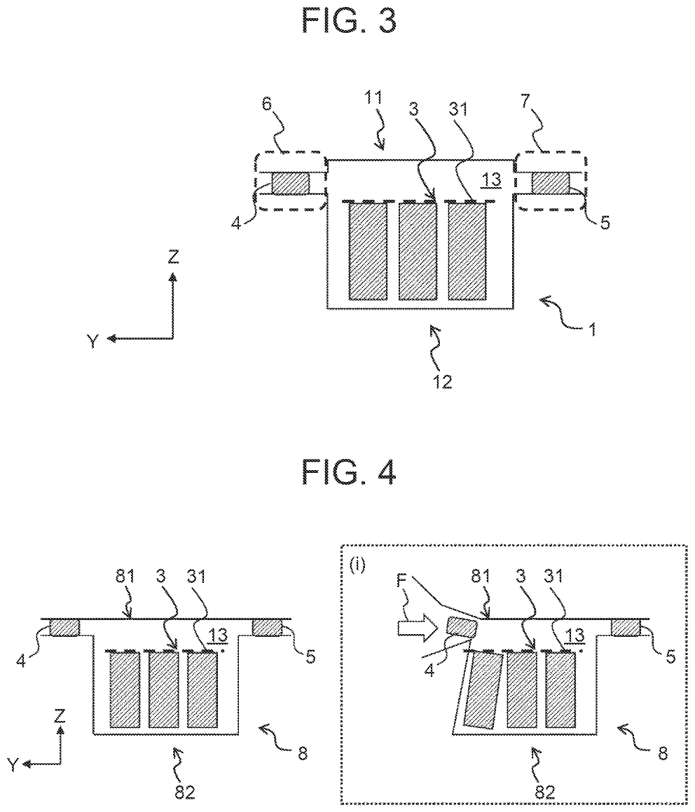

The combination positions of the upper cover 11 and the lower case 12 are positions where the right end portion 11b and the left end portion 11c respectively face the open edges 12b. The right end portion 11b combined with the open edge 12b forms a right flange 6, and the left end portion 11c combined with the open edge 12b forms a left flange 7 (cf., FIG. 3). At the position of the right flange 6, a seal member (e.g., seal rubber) 4 is provided between the lower surface of the right end portion 11b and the front surface of the open edge 12b to seal the space formed therebetween. At the position of the left flange 7, a seal member 5 is provided, having the same function as the seal member 4.

In the following, for convenience of explanation, reference will be made to FIG. 3 that simplifies the battery pack 1 illustrated in FIG. 2. FIG. 3 is a view illustrating a characteristic portion of the battery pack 1 illustrated in FIG. 2. FIG. 3 illustrates the positions of the right flange 6 and the left flange 7. As understood from this figure, the right flange 6 and the left flange 7 are positioned above the battery stack 3, and when the battery pack 1 is viewed from a direction parallel to the Y-axis, these flanges do not appear to overlap the battery stack 3. FIG. 3 also illustrates an upper surface 31 of the battery stack 3. The upper surface 31 is positioned below the front surfaces of the open edges 12b in contact with the seal members 4, 5.

### 2. Effects

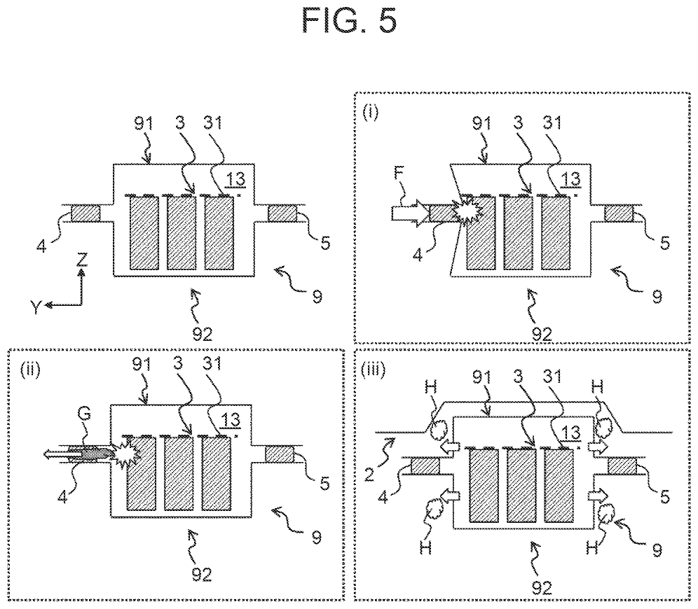

FIGS. 4 to 6 are views for explaining the effects of the battery pack 1 according to the embodiment. FIGS. 4 and 5 illustrate simplified battery packs 8, 9, respectively, similar to the battery pack 1 illustrated in FIG. 3. The battery packs 8, 9 correspond to comparative examples of the battery pack 1 according to the embodiment. The difference between the configurations of the battery packs 8, 9 and that of the battery pack 1 illustrated in FIG. 3 lies in the positions of the right and left flanges. The right and left flanges in the battery pack 8 are positioned higher than those in the battery pack 1. On the other hand, the right and left flanges in the battery pack 9 are positioned lower than those in the battery pack 1.

Specifically, in the battery pack 8, an upper cover 81 extends linearly in the direction parallel to the Y-axis, and there is no step at the end portion of the upper cover 81. Instead, an open edge of a lower case 82 moves in the positive Z-axis direction. On the other hand, in the battery pack 9, a right end portion of an upper cover 91 and an open edge of a lower case 92, which are both in contact with the seal member 4, are positioned below the upper surface 31. A left end portion of the upper cover 91 and an open edge of the lower case 92, which are both in contact with the seal member 5, are also positioned below the upper surface 31.

FIG. 4 illustrates: (i) an example of transmission of an external force F that is input to the battery pack 8 when a side collision occurs. The right flange of the battery pack 8 is positioned outermost in the positive Y-axis direction Therefore, when a side collision occurs, the external force F acts on the right flange first. Then, the mating surface between the upper cover 81 and the open edge of the lower case 82 constituting the right flange easily opens, and the seal structure of the right flange may not be able to be maintained.

FIG. 5 also illustrates: (i) an example of transmission of the external force F when a side collision occurs. In this example, the movement of the right flange in the negative Y-axis direction may cause the upper cover 91 and the lower case 92 connected to the right flange to bite into the battery stack 3. Further, FIG. 5 illustrates: (ii) an example of movement of gas G (e.g., combustible gas) ejected from the cells constituting the battery stack 3. In this example, the gas G generated at a position close to the right flange blows directly onto the seal member 4, which may impair the function of the seal member 4 and result in the leakage of the gas G to the outside of the battery pack 1. Moreover, FIG. 5 illustrates: (iii) an example of transfer of heat H generated from the battery stack 3. In this example, the heat H may tend to be trapped between the underbody 2 and each of the right and left flanges, necessitating the cooling of the battery stack 3.

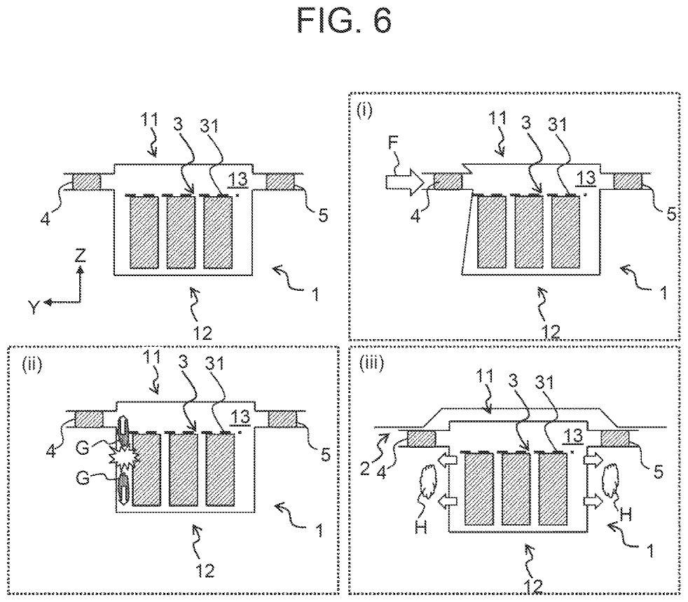

In this regard, the battery pack 1 according to the embodiment can reduce the defects described with reference to FIGS. 4 and 5. As illustrated in FIG. 6, in the case of (i) where a side collision occurs, the step formed in the upper cover 11 counters the external force F, so that the opening of the mating surface described in FIG. 4 can be suppressed. It is also possible to avoid the biting described with reference to FIG. 5. In addition, in the case of (ii), even when the gas G is sprayed at a position close to the right flange, the gas G can be prevented from being directly sprayed onto the seal member 4. Furthermore, in the case of (iii), the heat H generated from the battery stack 3 easily escapes into the atmosphere, so that the heat trapping described with reference to FIG. 5 can be prevented.

What is claimed is:

1. A battery pack that houses a battery stack to be mounted on a vehicle, the battery pack comprising:
an upper cover disposed to face a floor panel of the vehicle; and
a lower case combined with the upper cover, wherein
in a width direction of the vehicle, open edges of the lower case are combined with a left end portion and a right end portion of the upper cover to form a left flange and a right flange, respectively,
the left flange is attached to a left frame member of the vehicle provided on a left side of the floor panel, and the right flange is attached to a right frame member of the vehicle provided on a right side of the floor panel,
in the width direction, each of upper surfaces of the left flange and the right flange is positioned below an upper surface of the upper cover facing the floor panel, and
the upper surface of the upper cover facing the floor panel forms a step with each of the upper surfaces of the left flange and the right flange.

2. The battery pack according to claim 1, wherein the left flange and the right flange are positioned above the battery stack in the width direction.

3. The battery pack according to claim 1, wherein an upper surface of the battery stack is positioned below front surfaces of the open edges facing a lower surface of the left end portion and a lower surface of the right end portion at respective positions of the left flange and the right flange, the front surfaces each being a front surface of one of the open edges.

4. The battery pack according to claim 3, wherein:
a seal member is provided between the lower surface of the left end portion and the front surface of the open edge facing the lower surface of the left end portion to seal a gap formed between the lower surface of the left end portion and the front surface of the open edge; and
a seal member is provided between the lower surface of the right end portion and the front surface of the open edge facing the lower surface of the right end portion to seal a gap formed between the lower surface of the right end portion and the front surface of the open edge.
